(19) United States
(12) Patent Application Publication
(10) Pub. No.: US 2018/0272581 A1
(43) Pub. Date: Sep. 27, 2018

(54) INTEGRAL MOLDING METHOD AND INTEGRAL MOLDING DEVICE

(71) Applicant: CANON KABUSHIKI KAISHA, Tokyo (JP)

(72) Inventor: Yutaka Uematsu, Yokohama-shi (JP)

(21) Appl. No.: 15/912,797

(22) Filed: Mar. 6, 2018

(30) Foreign Application Priority Data
Mar. 21, 2017 (JP) 2017-055123

(51) Int. Cl. B29C 45/00; B29C 45/14; B29C 45/26

(52) U.S. Cl. CPC B29C 45/0046; B29C 45/2606; B29C 45/14065

(57) ABSTRACT

An insert member includes a bending portion, a first portion, and a second portion. The bending portion is interposed between the first portion and the second portion. A device for integrally molding the insert member and resin includes a holding portion configured to securely hold the first portion, a surface configured to contact a bottom surface of the second portion, and a gate configured to inject resin from a position nearer to the first portion than to the second portion, into a cavity. The cavity has a shape which causes a flow speed of the resin in a space above the second portion to be higher than a flow speed of the resin in a space at a side of the second portion.

### BACKGROUND OF THE INVENTION

### Field of the Invention

The present invention relates to an integral molding method which produces a product by using resin and a member having a bending portion, and to an integral molding device used for the integral molding method.

### Description of the Related Art

A method of integrally molding a resin material and a metal member is known. This method is used, for example, for increasing stiffness or creep strength of a molded resin product, or for forming an electric contact or a portion, which receives a mechanical action, in a molded resin product. For example, there is known an insert molding method in which a metallic insert member is placed in a mold, and then a resin material is injected into the mold to cover a periphery of the insert member with the resin material.

In such an insert molding method, if the insert member is displaced in the mold, the molded product may have a failure in its dimensions and shape. A possible reason for the displacement of the insert member, caused in the mold, is that the flowing resin material exerts a mechanical effect on the insert member when the resin material is injected into the cavity of the mold.

As a countermeasure to this, Japanese Patent Application Publication No. H8-207050 proposes one method. In this method, in a case where a metallic bolt is set, as an insert member, in a cavity formed by an upper mold and a lower mold and then injection molding is performed, a groove is formed on a headstream side of the flow of a resin material. The groove is formed in the upper mold at a position separated from the bolt, and intended to serve so that the resin material having flowed across the groove flows in a direction in which the bolt is pressed against the lower mold by the resin flow.

In the method described in Japanese Patent application Publication No. H8-207050, a foot portion of the bolt is fit into a concave portion of the lower mold, and a space surrounding a head portion of the bolt is filled with the resin having flowed across the groove, which is formed in the upper mold. Thus, the method is a displacement suppression method which is dedicated to bolt-shaped insert members.

However, shapes of insert members used for integral molding are not limited to a shape, such as the shape of the above-described bolt. For example, there is great demand for a product, in which an insert member having a bending portion, such as an L-shaped portion, and resin are integrally molded. If a metallic L-shaped insert member is used, and a surface of the metallic insert member is exposed from a surface of the molded product, the exposed portion can be used as a mechanical sliding surface, an electric contact, or a light reflection surface, or can be used for design purpose. In addition, if an L-shaped insert member made of a resin and having a color different from a color of the base-material resin is used, the exposed portion can be suitably used for design purpose.

In the manufacturing of such a molded product, if an L-shaped insert member is displaced in a mold, a surface of the insert member, which is expected to be exposed, may be covered with the resin, degrading its sliding property, electric conductivity, light reflectivity, and aesthetic appearance. In the case where the L-shaped insert member is used, the method of Japanese Patent Application Publication No. H8-207050 cannot be used because a vertically long portion of the L-shaped insert member stops the resin flow.

The present invention has been made to prevent an insert member, having a bending portion, from being displaced in a mold and produce a molded product with high accuracy of shape, when the insert member is placed in the mold and the mold is filled with resin.

### SUMMARY OF THE INVENTION

According to a first aspect of the present invention, a method of integrally molding an insert member and resin by using a mold capable of forming a cavity, the insert member including a bending portion, a first portion, and a second portion, the bending portion being interposed between the first portion and the second portion, the method includes setting the insert member to the cavity so that the first portion is held by the mold, and that the second portion is in contact with an inner surface of the mold, and injecting the resin from a position nearer to the first portion than to the second portion, into the cavity, and flowing the resin to a space above the second portion and a space at a side of the second portion, through a space at a side of the first portion. The cavity has a shape which causes a flow speed of the resin in the space above the second portion to be higher than a flow speed of the resin in the space at the side of the second portion.

According to a second aspect of the present invention, a device for integrally molding an insert member and resin, the insert member including a bending portion, a first portion, and a second portion, the bending portion being interposed between the first portion and the second portion, the device includes a holding portion configured to securely hold the first portion, a surface configured to contact a bottom surface of the second portion, and a gate configured to inject resin from a position nearer to the first portion than to the second portion, into a cavity. The cavity has a shape which causes a flow speed of the resin in a space above the second portion to be higher than a flow speed of the resin in a space at a side of the second portion.

Further features of the present invention will become apparent from the following description of exemplary embodiments with reference to the attached drawings.

### BRIEF DESCRIPTION OF THE DRAWINGS

FIG. 1A is an example of shape of a bending portion of an insert member which can be used in the present invention.

FIG. 1B is an example of shape of a bending portion of an insert member which can be used in the present invention.

FIG. 1C is an example of shape of a bending portion of an insert member which can be used in the present invention.

FIG. 1D is an example of shape of a bending portion of an insert member which can be used in the present invention.

FIG. 1E is an example of shape of a bending portion of an insert member which can be used in the present invention.

FIG. 2 illustrates a configuration of an insert member and a mold of a first embodiment.

FIG. 3A is an X-Z cross-sectional view illustrating a state where the insert member is set to the mold.

FIG. 3B is a top view illustrating the state where the insert member is set to the mold.

FIG. 4A is a Y-Z cross-sectional view of a cavity upstream portion.

FIG. 4B is a Y-Z cross-sectional view of a cavity middle portion.

FIG. 5A is an X-Z cross-sectional view of a cavity which schematically illustrates flow of resin.

FIG. 5B is an X-Y cross-sectional view of the cavity which schematically illustrates the flow of the resin.

FIG. 6 is an external view of an integrally molded product.

FIG. 7A is a front view of the integrally molded product.

FIG. 7B is a top view of the integrally molded product.

FIG. 7C is a bottom view of the integrally molded product.

FIG. 8 is a Y-Z cross-sectional view of a cavity middle portion of a second embodiment.

FIG. 9 is a Y-Z cross-sectional view of a cavity middle portion of a third embodiment.

FIG. 10A is an X-Z cross-sectional view of a cavity space at a side of an insert member, according to a fourth embodiment.

FIG. 10B is an X-Z cross-sectional view of another cavity space at a side of the insert member, according to the fourth embodiment.

FIG. 11A illustrates a configuration of an insert member and a mold of a fifth embodiment.

FIG. 11B is an X-Z cross-sectional view illustrating a state where the insert member is set to the mold.

FIG. 12 is a Y-Z cross-sectional view of a cavity middle portion of a sixth embodiment.

FIG. 13 is a Y-Z cross-sectional view of another cavity middle portion of the sixth embodiment.

FIG. 14 is a Y-Z cross-sectional view of another cavity middle portion of the sixth embodiment.

FIG. 15A is a perspective view of an integrally molded product of a seventh embodiment.

FIG. 15B is a top view of the integrally molded product of the seventh embodiment.

FIG. 16 is a schematic perspective view illustrating a molding method of an eighth embodiment.

### DESCRIPTION OF THE EMBODIMENTS

In the present invention, in order to integrally mold an insert member, including a bending portion, and a resin material by using a mold which can produce a cavity, a below-described cavity is produced by using the mold, and the resin material is injected into the cavity. Specifically, an integral molding device of the present invention has the cavity formed so that a flow speed of the resin in a space above the insert member is higher than a flow speed of the resin in a space at a side of the insert member, and the resin is injected into the cavity.

### Insert Member

A typical example of the insert member used in the present invention is an L-shaped member which is a metal plate bent at an angle of 90 degrees. However, the embodiments of the present invention are not limited to this. The insert member may be any member having a bending portion, and the present invention can be embodied with any of various shapes of insert members which are manufactured by using various methods, including bending.

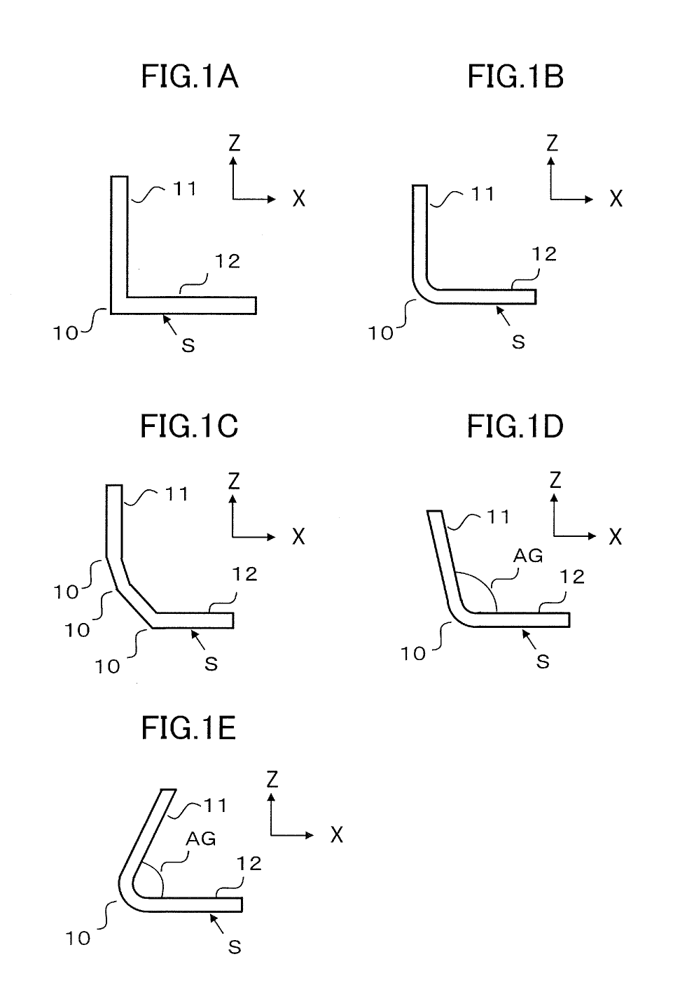

Here, FIGS. 1A to 1E illustrate examples of shape of the bending portion of the insert member. In the figures, there are illustrated a bending portion 10, a first portion 11, and a second portion 12. The first portion 11 and the second portion 12 are disposed so that the bending portion 10 is interposed between the first portion 11 and the second portion 12. As described below, the first portion 11 is a portion which is securely held by a mold during injection molding. A bottom surface S of the second portion 12 is a surface which is expected to be exposed from a surface of a molded product after the injection molding, and which is in contact with an inner surface of the mold during the injection molding.

As illustrated in FIG. 1A, the bending portion 10 may be shaped so as to have a sharp corner. As illustrated in FIG. 1B, the bending portion 10 may be constituted by a curved surface. For example, the bending portion 10 may be manufactured through a bending process, so as to have a round corner. As illustrated in FIG. 1C, a plurality of bending portions 10 may be formed between the first portion 11 and the second portion 12. An angle AG of the bending portion 10 may not necessarily be 90 degrees. The angle AG may be obtuse, as illustrated in FIG. 1D; or may be acute, as illustrated in FIG. 1E. The angle of the bending portion 10 is not limited to the above-described angles as long as the bending portion 10 is formed so that the first portion 11 can be securely held and the bottom surface S of the second portion 12 can be in contact with the inner surface of the mold. However, the angle AG is preferably 60 degrees or more and 120 degrees or less.

The material of the insert member is not limited to metal. For example, the material may be a transparent resin, or a colored resin whose color is different from a color of an injected resin. The material may be produced through injection molding.

The present invention can be applied to any insert members including the above-exemplified shapes of insert members, as long as the insert members each have the first portion and the second portion disposed so that the bending portion is interposed between the first portion and the second portion, and as long as the surface of the second portion is intended to be exposed from an outer surface of a molded product.

### First Embodiment

An integral molding method of a first embodiment of the present invention, and an insert molding device used for the integral molding method will be described, for example, for a case where the molding is performed using the L-shaped insert member illustrated in FIG. 1A.

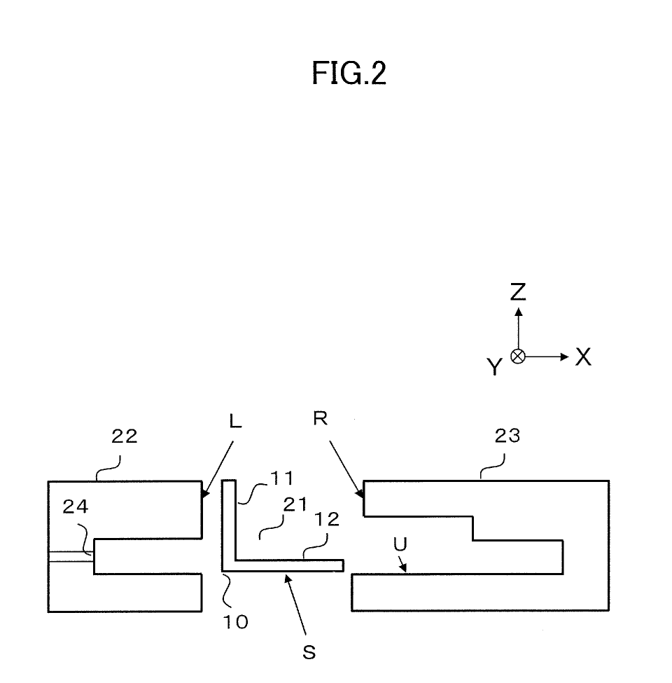

FIG. 2 schematically illustrates a state before the insert member is set to an insert molding mold. In FIG. 2, there are illustrated an insert member 21, the bending portion 10 of the insert member 21, the first portion 11 of the insert member 21, and the second portion 12 of the insert member 21. In addition, there are also illustrated a first mold 22 which is one portion of the insert molding mold, a second mold 23 which is the other portion of the insert molding mold, and a gate 24 which is used to inject resin into the cavity.

When the insert member 21 is set to the insert molding mold, the insert member 21 is disposed so that a bottom surface S of the second portion 12 of the insert member 21 is in contact with an inner surface U of the second mold 23. Then the first portion 11 of insert member 21 is sandwiched between a side surface L of the first mold 22 and a side surface R of the second mold 23, and thereby securely held. That is, the side surface L of the first mold 22 and the side surface R of the second mold 23 serve as a holding portion which holds the first portion 11 of the insert member 21.

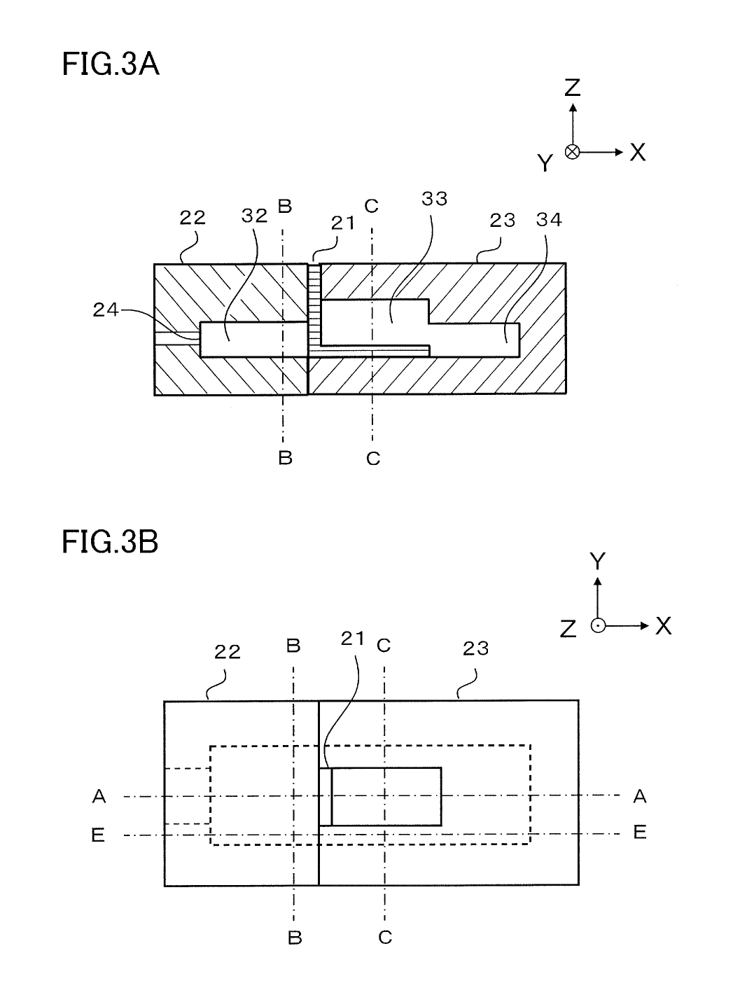

FIGS. 3A and 3B illustrate a state where the insert member 21 is set to the insert molding mold. FIG. 3A is a cross-sectional view in an X-Z plane. FIG. 3B is a plan view seen from a Z-direction. FIG. 3A illustrates a cross-sectional shape taken along a line A-A of FIG. 3B.

As illustrated in FIG. 3A, the first portion of the insert member 21 is sandwiched between the first mold and the second mold 23. The bottom surface of the second portion of the insert member 21 is in contact with the inner surface of the second mold 23. The first mold 22 and the second mold 23 form a cavity. For convenience, a space of the cavity between the gate 24 and the insert member 21 is referred to as an upstream portion 32. A space of the cavity where the insert member 21 is disposed is referred to as a middle portion 33. A space of the cavity on the downstream side with respect to the insert member 21 is referred to as a downstream portion 34. The resin injected from the gate 24 into the cavity flows in an X-direction indicated in FIGS. 3A and 3B, and fills the upstream portion 32, the middle portion 33, and the downstream portion 34. The shape of the flow channel of the resin in the cavity will be described later.

FIG. 3B is the plan view illustrating an external appearance of the insert molding mold seen from above. In the plan view, the insert member 21 is set to the insert molding mold. The dotted line of FIG. 3B indicates an internal shape which cannot be seen from the outside.

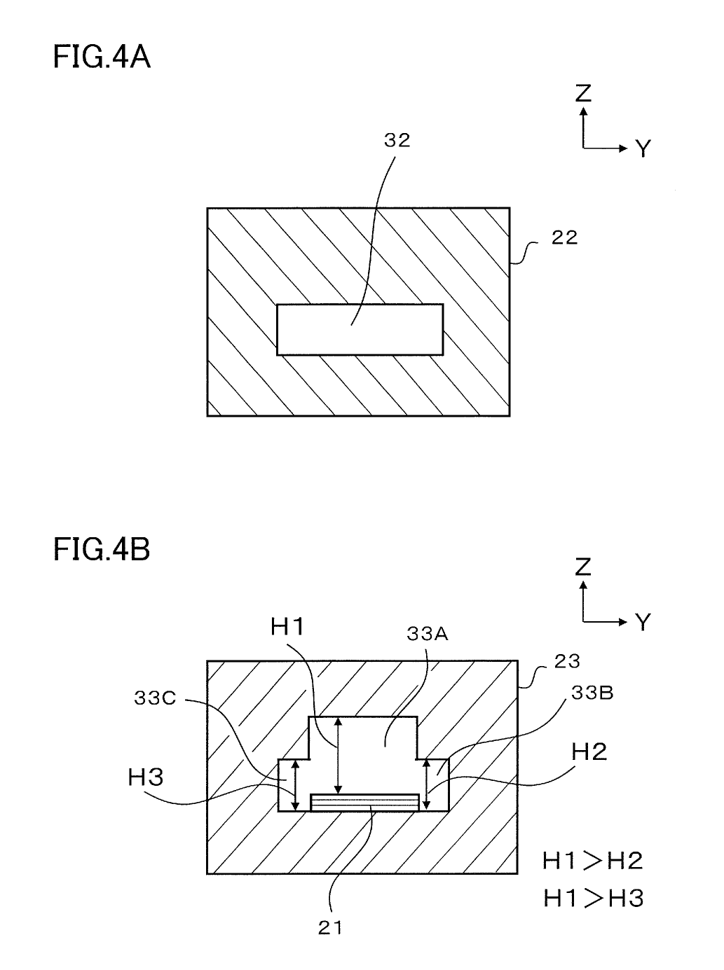

Next, with reference to FIGS. 4A and 4B, cross-sectional shapes of a resin flow channel will be described. Here, the cross-sectional shapes are shapes in the upstream portion 32 and the middle portion 33 of the cavity. FIG. 4A is a cross-sectional view of the insert molding mold, taken along a line B-B of FIGS. 3A and 3B. FIG. 4B is a cross-sectional view of the insert molding mold, taken along a line C-C of FIGS. 3A and 3B.

As illustrated in FIG. 4A, the cross-sectional shape of the flow channel in the upstream portion 32 is rectangular. The shape of this portion depends on specifications of a corresponding molded product, but is required to have a sufficient cross-sectional area of the flow channel for flowing the resin up through the middle portion and the downstream portion of the cavity.

Next, the shape of the resin flow channel in the middle portion 33, in which the insert member 21 is disposed, will be described. As illustrated in FIG. 4B, there are a cavity space 33A above the insert member 21 (in a Z-direction), and cavity spaces 33B and 33C at the sides of the insert member 21 (in a Y-direction).

Here, H1 is a height of the cavity space 33A from an upper surface of the insert member 21 to a ceiling of the mold 23, H2 is a height of the cavity space 33B from the floor surface of the mold 23 to a ceiling, and H3 is a height of the cavity space 33C from the floor surface of the mold 23 to a ceiling. In the present embodiment, the shape of the cavity is formed so that H1>H2 and H1>H3. With the cavity having such a structure, the flow speed of the resin in the cavity space 33A can be higher than the flow speed of the resin in the cavity spaces 33B and 33C.

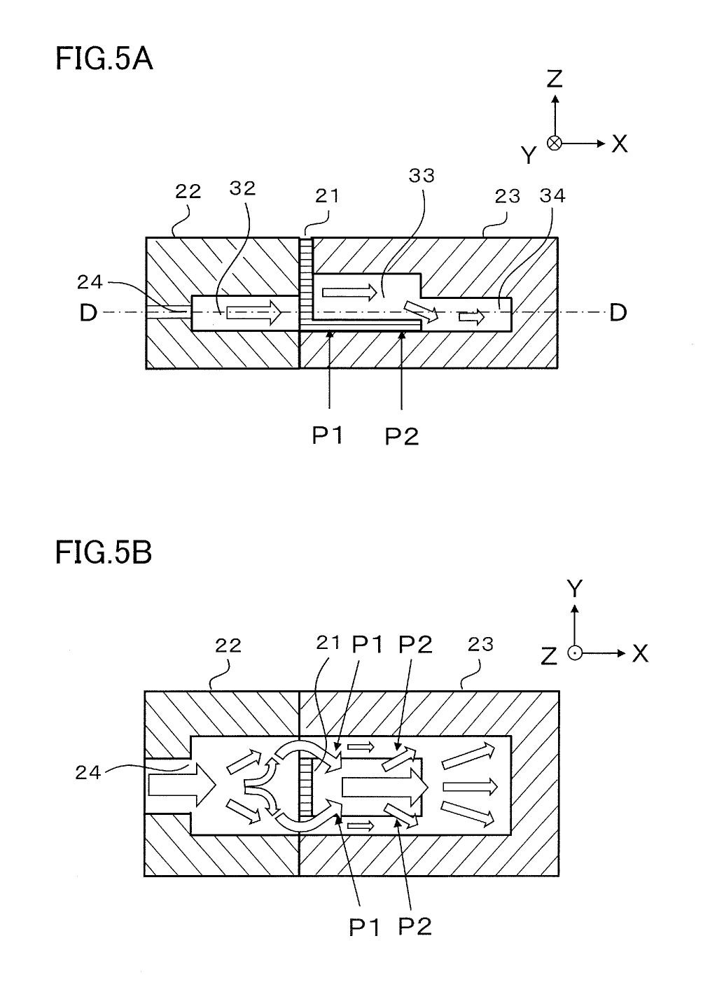

With reference to FIGS. 5A and 5B, the resin flow will be specifically described. FIG. 5A is the cross-sectional view in an X-Z plane, taken along the line A-A of FIG. 3B, as is in FIG. 3A. The reference numerals of components of FIG. 5A are the same as those of FIG. 3A. FIG. 5B is a cross-sectional view in an X-Y plane, taken along a line D-D of FIG. 5A.

In FIGS. 5A and 5B, arrows in the cavity spaces schematically indicate flow of the resin, which is injected into the cavity. As illustrated in FIG. 5A, the resin injected from the gate 24 flows downstream in the upstream portion 32. However, because the first portion of the insert member 21 stands and blocks the flow, the resin takes detours along both sides of the insert member 21 and flows into the middle portion 33, as illustrated in FIG. 5B. As illustrated in FIGS. 2 and 3A, the bottom surface S of the insert member 21 is disposed so as to be in contact with the inner surface U of the second mold 23. But if the resin enters a gap between the bottom surface S and the inner surface U, the bottom surface S, which is expected to be exposed at the completion of the molded product, is disadvantageously covered with the resin.

In the present embodiment, the resin having taken the detours along both sides of the insert member 21 not only flows downstream through spaces at the sides of the insert member 21, but also flows toward the insert member 21, in an area in the vicinity of a position P1 indicated in FIGS. 5A and 5B. Here, a portion of the insert member 21 in the area in the vicinity of the position P1 is close to the first portion sandwiched between the first and the second molds and securely held, and thus the portion of the insert member 21 is in close contact with a top surface of the mold and retained. Thus, even when the pressure of the resin flow is applied to the insert member 21 from both sides of the insert member 21, in the area in the vicinity of the position P1, the resin does not enter the gap between the bottom surface S and the inner surface U.

On the other hand, in another area which is far from the first portion sandwiched between the first and the second molds, that is, in an area in the vicinity of a position P2 indicated in FIGS. 5A and 5B, the retaining force, which causes the bottom surface S to closely contact the inner surface U, becomes weaker than that in the area in the vicinity of the position P1. Thus, when the pressure of the resin flow is applied to the insert member 21 from both sides of the insert member 21, in the area in the vicinity of the position P2, the resin may enter the gap between the bottom surface S and the inner surface U.

In the present embodiment, as illustrated in FIG. 4B, the cavity space 33A above the insert member 21 is higher in height than the cavity spaces 33B and 33C at the sides of the insert member 21, and allows more resin to flow faster. Thus, as illustrated in FIGS. 5A and 5B, the resin which flows above the insert member 21 precedes the resin which flows through the spaces at the sides of the insert member 21, in the space between P1 and P2; and flows from the above of the insert member 21 to the sides of the insert member 21, in the area in the vicinity of the position P2. Thus, in the present embodiment, the pressure of the resin flow is not applied to the insert member 21 from the sides of the insert member 21, in the area in the vicinity of the position P2 where the retaining force, which causes the insert member 21 to closely contact the mold, is weak. Therefore, the present embodiment can effectively prevent the resin from entering the gap between the bottom surface S and the inner surface U.

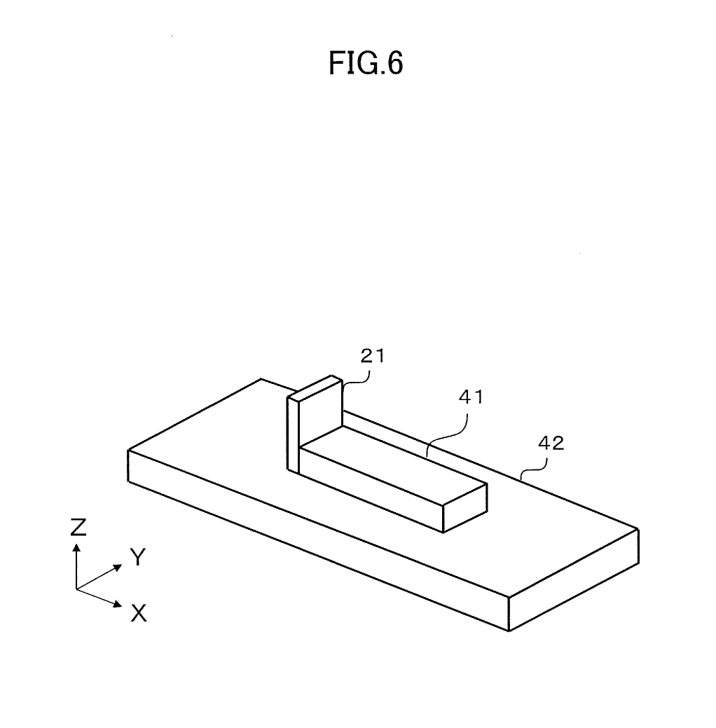

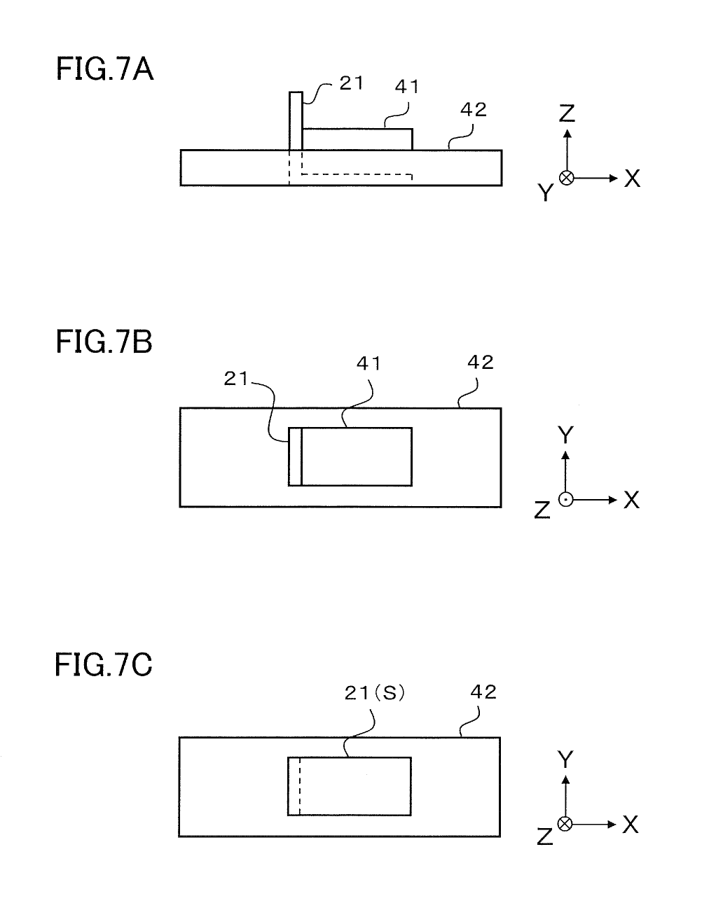

FIG. 6 and FIGS. 7A to 7C illustrate a molded product which is produced by using the above-described integral molding method of the present embodiment. FIG. 6 is a perspective view illustrating an external appearance of the molded product. FIGS. 7A, 7B, and 7C are respectively a front view, a top view, and a bottom view of the molded product. In the figures, there are illustrated the insert member 21, and resin portions 41 and 42. The resin portion 41 increases fixing strength for the insert member of the molded product, and structural strength of the integrally molded product as a whole.

As illustrated in FIG. 7C, the insert member 21 is exposed from the bottom surface of the integrally molded product. Since the integral molding method of the present embodiment can effectively prevent the resin from entering the gap between the mold and the insert member, the exposure portion is not covered with the resin. The clean surface of the insert member is exposed from the surface of the molded product, and the molded product can be manufactured with high accuracy of shape and high quality, and with a high yield.

In the above-described examples, cross-sectional shapes of the cavity space above the insert member and the cavity spaces at the sides of the insert member are rectangular shapes having different heights. The present embodiment, however, is not limited to rectangular shapes. The point is that the cavity only has to be formed so that the cavity space above the insert member is higher in height than the cavity spaces at the sides of the insert member.

### Second Embodiment

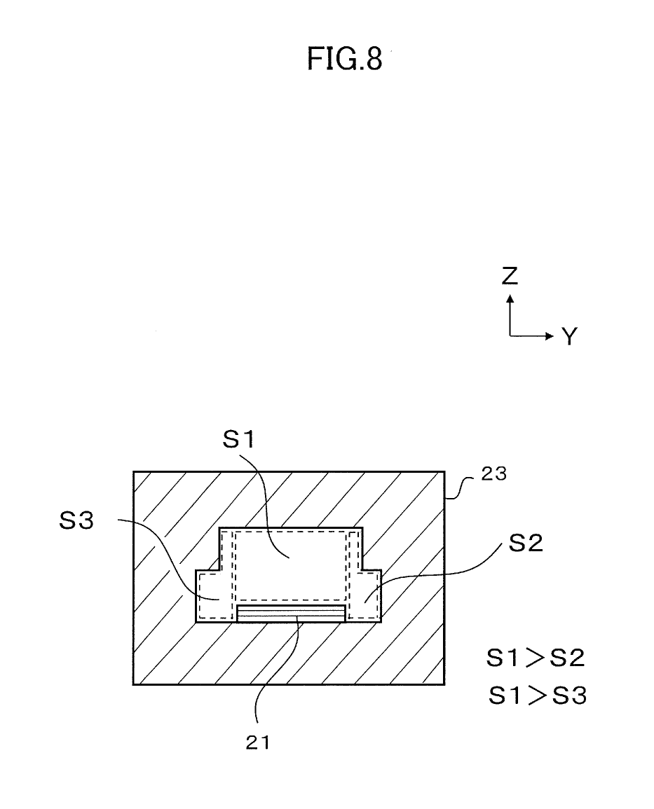

FIG. 8 is a Y-Z cross-sectional view for illustrating a flow channel cross-sectional shape of a middle portion of a second embodiment. In the second embodiment, a flow channel cross-sectional area S1 of the cavity space above the insert member is larger than a flow channel cross-sectional area S2 of the cavity space at one side of the insert member, and than a flow channel cross-sectional area S3 of the cavity space at the other side of the insert member. That is, the cavity is formed so that S1>S2 and S1>S3 are satisfied.

Since the space above the insert member has the larger flow channel cross-sectional area, the conductance of the space above the insert member increases. As a result, the flow speed of the resin in the space above the insert member can be higher than the flow speed of the resin in the spaces at the sides of the insert member.

Also in the second embodiment, the resin which flows above the insert member precedes the resin which flows through the spaces at the sides of the insert member, in the space between P1 and P2, as is in the description for FIGS. 5A and 5B of the first embodiment. Thus, in the area in the vicinity of the position P2, the resin flows from the above of the insert member to the sides of the insert member. Thus, in the present embodiment, the pressure of the resin flow is not applied to the insert member 21 from the sides of the insert member 21, in the area in the vicinity of the position P2 where the retaining force, which causes the insert member 21 to closely contact the mold, is weak. Therefore, the present embodiment can effectively prevent the resin from entering the gap between the bottom surface S and the inner surface U.

Since the present embodiment can effectively prevent the resin from entering the gap between the mold and the insert member, the molded product, which has the insert member whose clean surface is exposed, can be manufactured with high accuracy of shape and high quality, and with a high yield.

In the example of FIG. 8, one portion of each of the cavity spaces at the sides of the insert member has a higher height than the other, and thus the width of the insert member in the Y-direction is relatively narrowed. The present embodiment, however, is not limited to this. The point is that the cavity only has to be formed so that the cavity space above the insert member has a larger flow channel cross-sectional area than those of the cavity spaces at the sides of the insert member.

### Third Embodiment

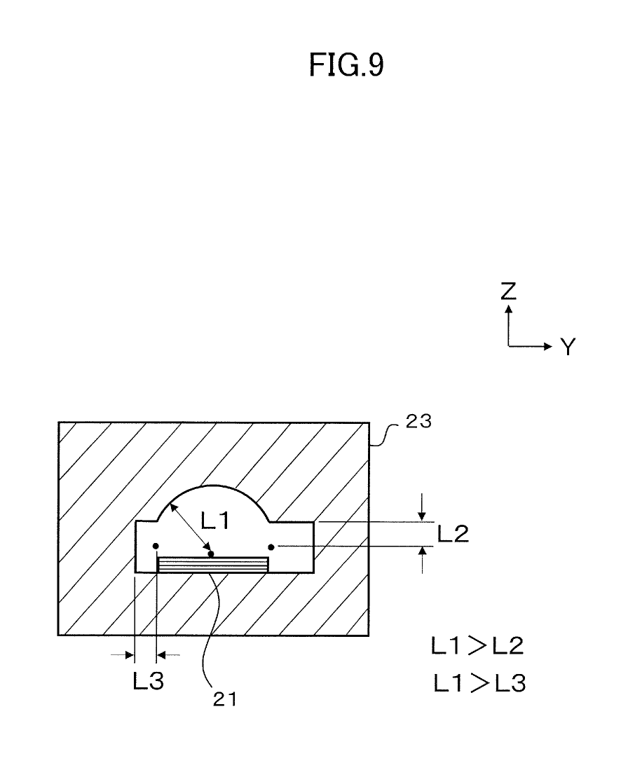

FIG. 9 is a Y-Z cross-sectional view for illustrating a flow channel cross-sectional shape of a middle portion of a third embodiment. In the third embodiment, the cavity is formed so that the cavity space above the insert member has more space than the cavity spaces at the sides of the insert member. Here, the above-described space is a space located far from a wall surface of the insert molding mold. As illustrated in FIG. 9, each of the cavity spaces has a point which is farthest from a corresponding wall surface of the mold. Thus, the cavity spaces have distances L1, L2, and L3 between the respective points and respective wall surfaces of the mold. In the example of FIG. 9, in the cavity space above the insert member, the cross section of the cavity space is a semicircle, and the position which is farthest from a corresponding wall surface of the mold is in the vicinity of a center of the top surface of the insert member, and is apart from the corresponding wall surface by L1. In FIG. 9, in the cavity space at the right side of the insert member, the point which is farthest from a corresponding wall surface of the mold is close to the insert member in the Y-direction, positioned at a center of the height of the cavity space in the Z-direction, and apart from the corresponding wall surface of the mold by L2. In the cavity space at the left side of the insert member, the point which is farthest from a corresponding wall surface of the mold is apart from the corresponding wall surface of the mold by L3. In the present embodiment, the cavity is formed so that L1>L2 and L1>L3 are satisfied.

In general, shortening the process time of injection molding needs to increase the speed at which the resin, which has filled the cavity, solidifies. For this reason, the temperature of the insert molding mold is set lower than a melting temperature of the resin. Thus, the resin which flows through a portion of the cavity closer to the wall surface of the mold is cooled more quickly, and has a higher viscosity and a slower flow speed. In the present embodiment, the cavity space above the insert member has more space, located far from the wall surface of the insert molding mold, than the cavity spaces at the sides of the insert member. As a result, the cavity space above the insert member allows more resin to flow with its constant faster flow speed.

Also in the third embodiment, the resin which flows above the insert member precedes the resin which flows through the spaces at the sides of the insert member, in the space between P1 and P2, as is in the description for FIGS. 5A and 5B of the first embodiment. Thus, in the area in the vicinity of the position P2, the resin flows from the above of the insert member to the sides of the insert member. Thus, in the present embodiment, the pressure of the resin flow is not applied to the insert member 21 from the sides of the insert member 21, in the area in the vicinity of the position P2 where the retaining force, which causes the insert member 21 to closely contact the mold, is weak. Therefore, the present embodiment can effectively prevent the resin from entering the gap between the bottom surface S and the inner surface U.

Since the present embodiment can effectively prevent the resin from entering the gap between the mold and the insert member, the molded product, which has the insert member whose clean surface is exposed, can be manufactured with high accuracy of shape and high quality, and with a high yield.

In the example of FIG. 9, the ceiling of the cavity space above the insert member is formed in a semicircle, and the cavity spaces at the sides of the insert member, which sandwich the insert member, are asymmetrical to each other. The present embodiment, however, is not limited to these. The point is that the cavity only has to be formed so that the cavity space above the insert member has more space, located far from the wall surface of the insert molding mold, than the cavity spaces at the sides of the insert member.

### Fourth Embodiment

In the first embodiment, in the region indicated as the middle portion 33 in FIG. 3A, that is, in the region in which the second portion of the insert member is disposed, any cross section of the cavity has an identical shape, as illustrated in FIG. 4B. In a fourth embodiment, the shape of the cavity spaces at the sides of the insert member is changed along the resin flow channel. That is, in the cavity spaces at the sides of the insert member, the height of the cavity spaces is decreased along the resin flow direction, or the flow channel cross-sectional area of the cavity spaces is decreased along the resin flow direction. With this structure, the speed of the resin which flows though the cavity spaces at the sides of the insert member is reduced.

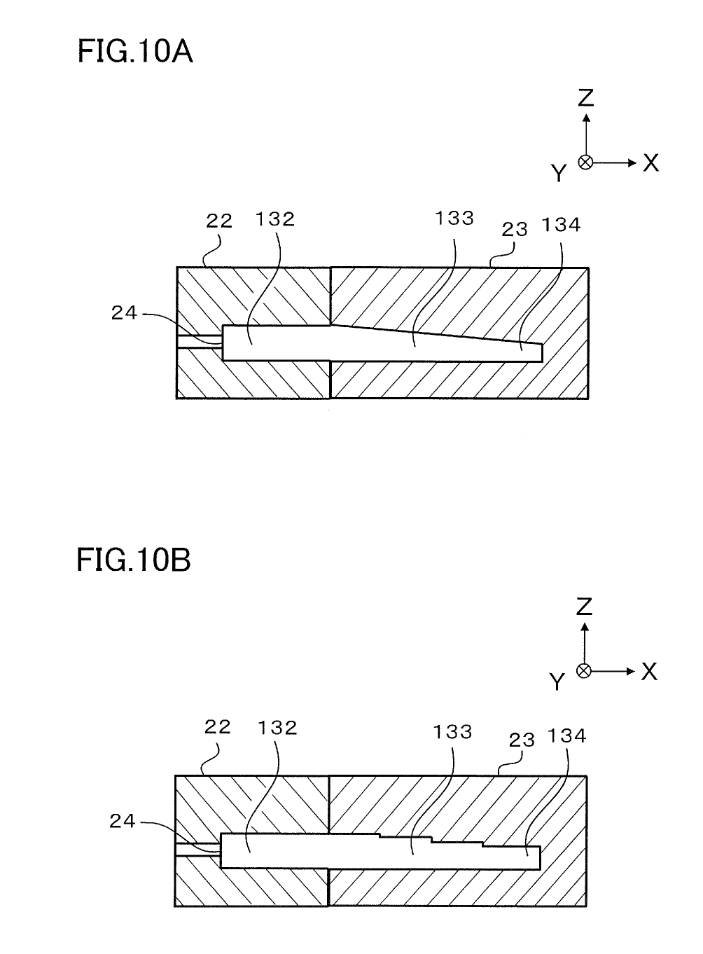

FIG. 10A is a cross-sectional view of the cavity in an X-Z plane, taken along a line E-E of FIG. 3B, which is used for the description of the first embodiment. As illustrated in FIG. 10A, in the middle portion 133, the height or the flow channel cross-sectional area of the cavity spaces at the sides of the insert member is gradually decreased along the resin flow direction. With such a structure, the speed of the resin which flows through the cavity spaces at the sides of the insert member can be reduced, and the resin which flows through the cavity space above the insert member can reliably precede. As a result, the effect described by using FIG. 5, that is, the effect in which the resin is prevented from entering the gap between the bottom surface of the insert member and the mold in the vicinity of P2 can be more enhanced than the first embodiment.

The shape of the cavity spaces at the sides of the insert member is not limited to the shape illustrated in FIG. 10A, and may be any shape as long as the speed of the flowing resin can be reduced. For example, as illustrated in FIG. 10B, the height or the flow channel cross-sectional area of the cavity spaces may be decreased in a staircase pattern, along the resin flow direction. In another case, the height of the cavity spaces of only the middle portion 133 may be decreased in the downstream direction; the height of the cavity spaces of both the middle portion 133 and the downstream portion 134 may be decreased in the downstream direction; or the height of the cavity spaces of all the region from the upstream portion 132 to the downstream portion 134 may be decreased in the downstream direction.

### Fifth Embodiment

In the first embodiment, as illustrated in FIG. 2, the first mold 22 and the second mold 23 form the cavity. However, the insert molding mold may not necessarily be constituted by two molds. Also in the first embodiment, the bottom surface S of the second portion 12 of the insert member, which has the bending portion, is placed on the inner surface U of the mold 23, which is disposed opposite to the gate 24. The present disclosure, however, is not limited to this layout. In addition, the height of the downstream portion of the cavity may not necessarily be lower than the height of the middle portion of the cavity.

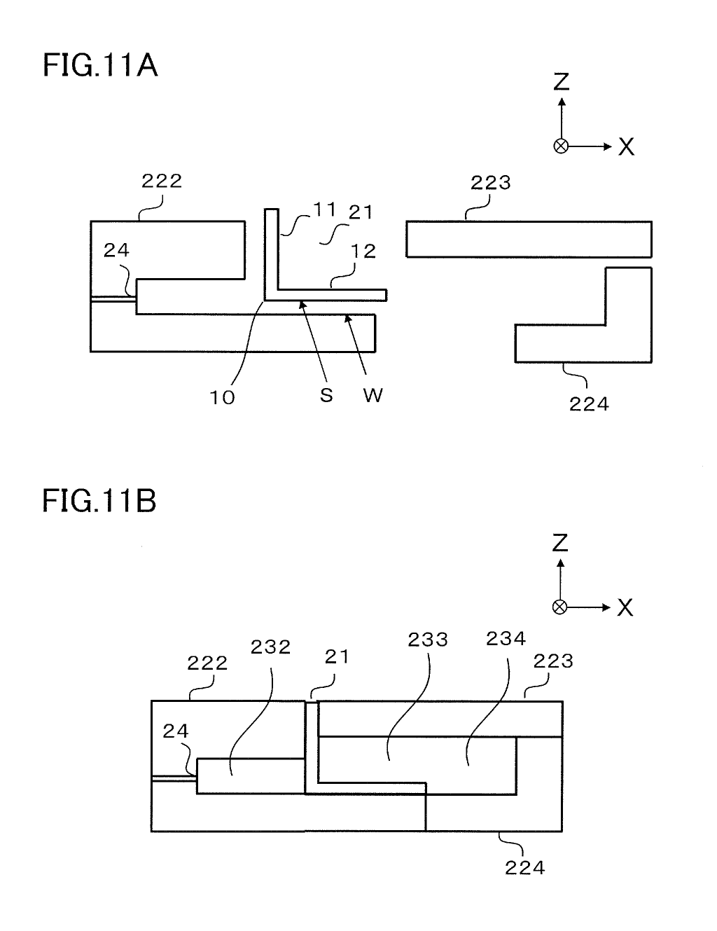

FIG. 11A is a schematic diagram illustrating a state before the insert member is set to an insert molding mold, in a fifth embodiment which uses three molds. In FIG. 11A, there are illustrated the insert member 21, the bending portion 10 of the insert member 21, the first portion 11 of the insert member 21, and the second portion 12 of the insert member 21. In addition, there are also illustrated a first mold 222 which is one portion of the insert molding mold, a second mold 223 which is one portion of the insert molding mold, a third mold 224 which is one portion of the insert molding mold, and the gate 24 which is used to inject resin into the cavity.

When the insert member 21 is set to the insert molding mold, the insert member 21 is disposed so that the bottom surface S of the second portion 12 of the insert member 21 is in contact with an inner surface W of the first mold 222. The first portion 11 of insert member 21 is sandwiched between a side surface of the first mold 222 and a side surface of the second mold 223, and thereby securely held.

FIG. 11B illustrates a state where the insert member is set to the insert molding mold. The first portion of the insert member 21 is sandwiched between the first mold 222 and the second mold 223. The bottom surface of the second portion of the insert member 21 is in contact with the inner surface of the first mold 222. The resin injected from the gate 24 into the cavity flows in the X-direction indicated in FIGS. 11A and 11B, and fills the upstream portion 232, the middle portion 233, and the downstream portion 234. The height of the middle portion 233 of the cavity is set equal to the height of the downstream portion 234 of the cavity.

Since the present embodiment can also effectively prevent the resin from entering the gap between the mold and the insert member as in the first embodiment, the exposure portion of the insert member is not covered with the resin. The clean surface of the insert member is exposed, and the molded product can be manufactured with high accuracy of shape and high quality, and with a high yield.

### Sixth Embodiment

The shape of the cavity, which allows the resin flow through the cavity space above the insert member to precede the resin flow through the cavity spaces at the sides of the insert member, is not limited to the above-described examples.

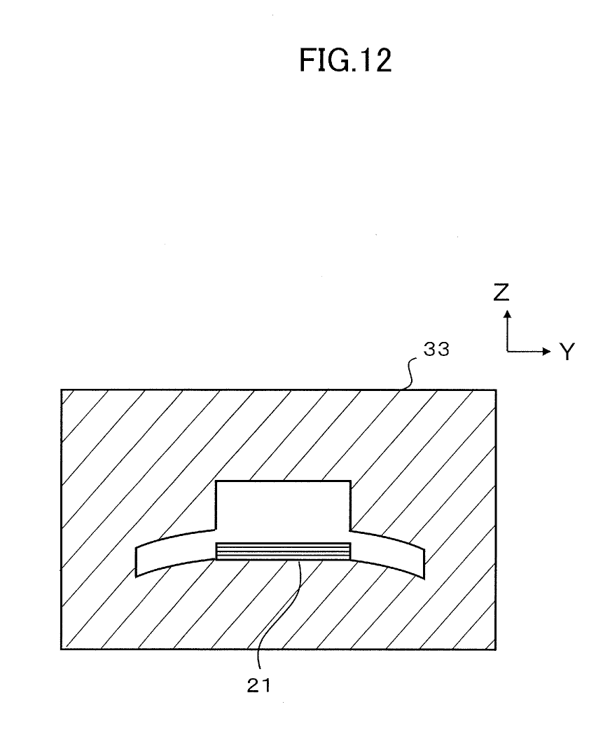

In the examples of FIGS. 4B, 8, and 9, the surface of the mold on which the insert member is placed, and floor surfaces of the cavity spaces at the sides of the insert member are flat and continuous with each other, having an identical height. The present disclosure, however, is not limited to this. In addition, the cross-sectional shape of the cavity space above the insert member is not limited to the rectangle as illustrated in FIG. 4B and FIG. 8, or the semicircle as illustrated in FIG. 9. For example, as illustrated in a Y-Z cross-sectional shape of FIG. 12, the floor surfaces of the cavity spaces at both sides of the insert member may be sloping curved surfaces.

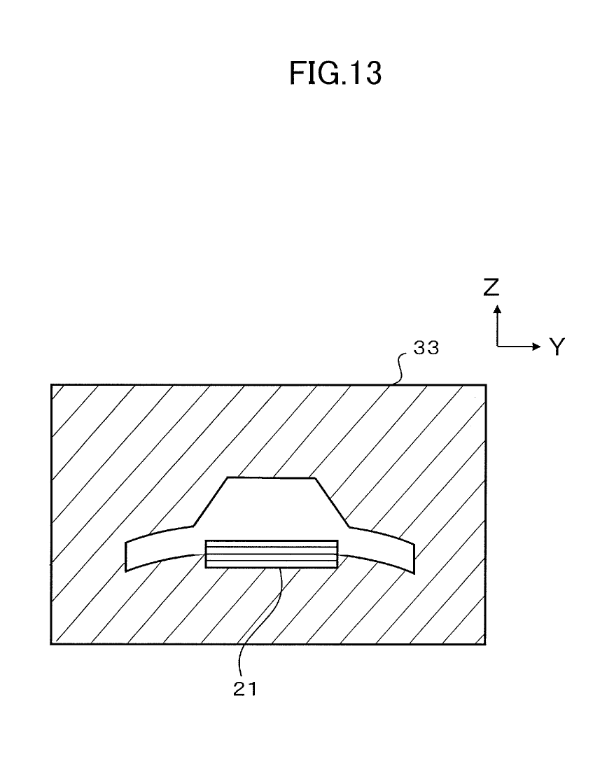

As illustrated in a Y-Z cross-sectional shape of FIG. 13, the following structure may be used: the floor surfaces of the cavity spaces at both sides of the insert member are sloping curved surfaces; the surface on which the insert member is placed is lowered; and the cavity space above the insert member has a cross-sectional shape of a polygon, such as a trapezoid.

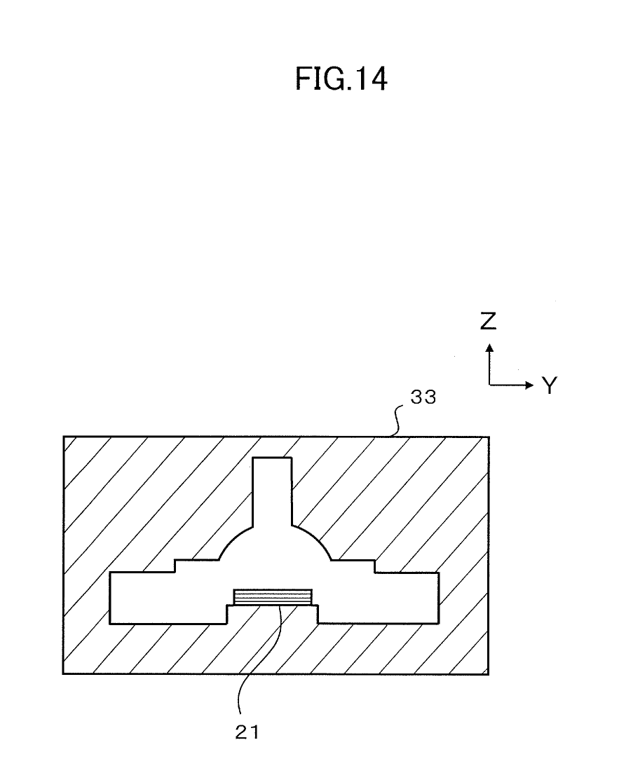

As illustrated in a Y-Z cross-sectional shape of FIG. 14, the following structure may be used: the surface on which the insert member is placed is raised; and the cavity has a cross-sectional shape in which a semicircle and rectangles are combined.

Shapes of the cavity spaces may be determined by appropriately selecting and satisfying one, two or more, or all of the following conditions: the space above the insert member has a higher height than the spaces at the sides of the insert member; the space above the insert member has a larger flow channel cross-sectional area than the spaces at the sides of the insert member; and the space above the insert member has a larger distance from the corresponding inner surface of the mold, than the spaces at the sides of the insert member. In any combination of the conditions, the shape of the cavity spaces at the sides of the insert member can be changed toward the downstream direction, as in the fourth embodiment.

### Seventh Embodiment

In any embodiment of the present invention, the number of insert members contained in an integrally molded product may not be one. For example, as a modification of the embodiment illustrated in FIG. 12, a cylindrical integrally molded product which contains a plurality of insert members can be produced.

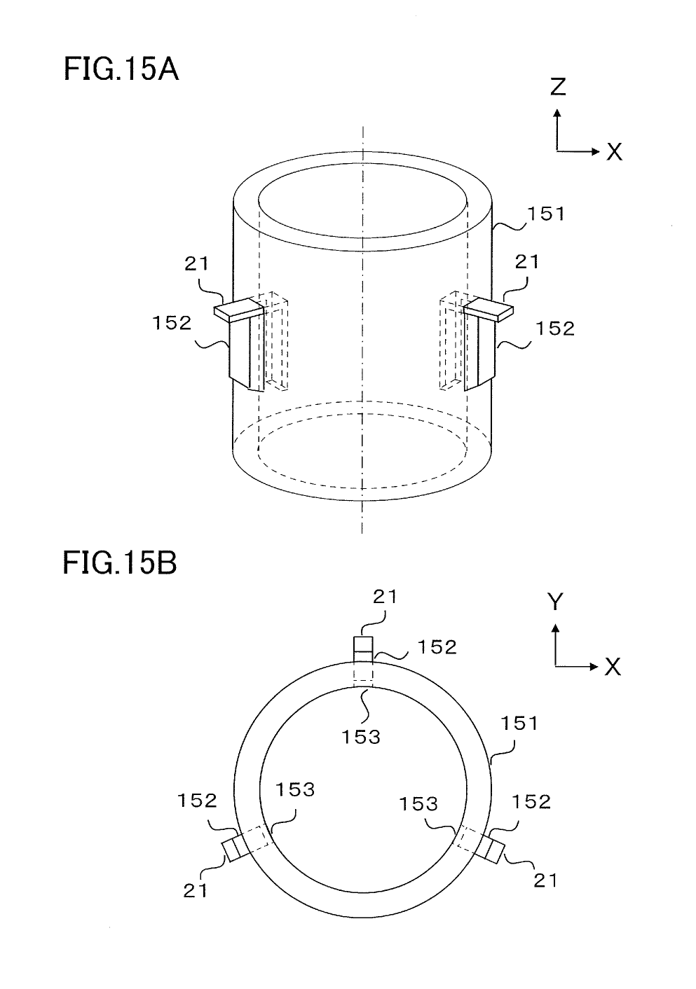

FIGS. 15A and 15B are, respectively, a perspective view and a top view of such a molded product. As illustrated in the figures, a cylindrical molded resin product 151 is provided with three insert members 21 and resin portions 152. Each of the insert members 21 is an L-shaped metallic member having a bending portion, and each of the resin portions 152 is formed in a portion which has served as a space above a corresponding insert member during the molding. The molded product is formed by filling a cylindrical cavity space with resin, by flowing the resin toward a downward direction in FIG. 15A. Here, the cavity space, in which the resin portion 152 is to be formed, is formed above the insert member. With this configuration, the resin is prevented from entering the gap between the bottom surface of each insert member and the mold. Thus, the insert members are arranged with high positional accuracy, and bottom surfaces 153 of the insert members are cleanly exposed from the inner surface of the cylindrical molded resin product 151 without covered with the resin.

### Eighth Embodiment

In any embodiment of the present invention, when an insert member is set to a mold used for integral molding, the insert member may be connected to other insert members like a hoop (long ribbon), to shorten the cycle time of the molding.

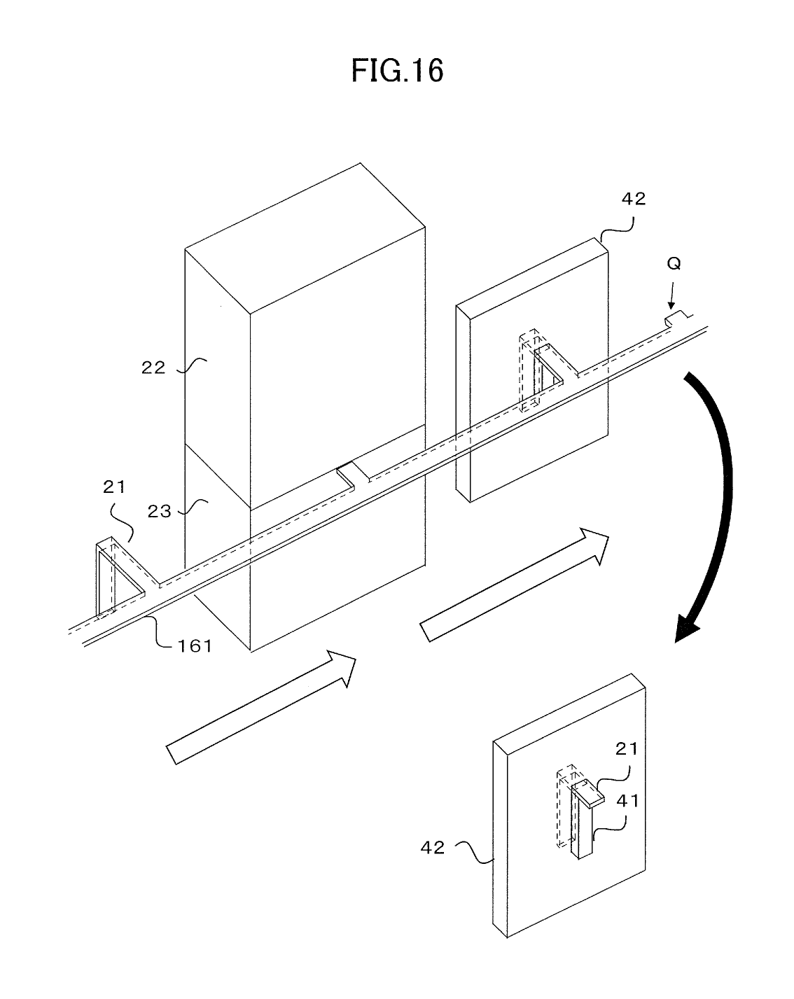

FIG. 16 is a schematic diagram illustrating a case where insert members connected with each other, like a hoop, are used for the molding method of the first embodiment. A plurality of L-shaped insert members 21 are joined with a conveyance portion 161 formed like a long ribbon, at predetermined intervals. A conveyance mechanism (not illustrated) sequentially conveys the insert members 21 in a direction indicated by arrows in FIG. 16, and feeds the insert members 21, one by one, to a cavity formed by molds 22 and 23. After the molding, each insert member is cut off at a point Q, and each molded product is separated from the conveyance portion 161. In the present embodiment, because the insert members can be successively fed to the cavity, the molding method of the present invention can be embodied in a short cycle time.

The present invention is not limited to the above-described first to eighth embodiments, and can be embodied by appropriately changing or combining the embodiments. In a case where the insert member and the molded product have different shapes, the shape of the cavity may be appropriately changed by changing the mold. For example, although the resin flows from the upstream portion to the middle portion through the spaces at both sides of the first portion of the insert member 21 in the embodiment of FIG. 5B, the cavity may be formed so that the resin flows through a space at only one side of the first portion. In another case, the first portion of the insert member may be provided with a window through which the resin can pass, and thus not only the spaces at the sides of the first portion but also the window may constitute a flow channel through which the resin flows toward the middle portion. Thus, in the embodiments of the present invention, when an insert member having a bending portion is placed in a mold and the mold is filled with resin, the insert member can be prevented from being displaced in the mold, and a molded product can be manufactured with high accuracy of shape.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-055123, filed Mar. 21, 2017, which is hereby incorporated by reference wherein in its entirety.

What is claimed is:

1. A method of integrally molding an insert member and resin by using a mold capable of forming a cavity, the insert member comprising a bending portion, a first portion, and a second portion, the bending portion being interposed between the first portion and the second portion, the method comprising:
setting the insert member to the cavity so that the first portion is held by the mold, and that the second portion is in contact with an inner surface of the mold; and
injecting the resin from a position nearer to the first portion than to the second portion, into the cavity, and flowing the resin to a space above the second portion and a space at a side of the second portion, through a space at a side of the first portion,
wherein the cavity has a shape which causes a flow speed of the resin in the space above the second portion to be higher than a flow speed of the resin in the space at the side of the second portion.

2. The method according to claim 1, wherein the cavity is formed so that a height of the space above the second portion from a top surface of the second portion to a ceiling of the cavity is higher than a height of the space at the side of the second portion from a floor surface of the cavity to a ceiling of the cavity.

3. The method according to claim 1, wherein the cavity is formed so that a cross-sectional area of a resin flow channel in the space above the second portion is larger than a cross-sectional area of a resin flow channel in the space at the side of the second portion.

4. The method according to claim 1, wherein, in the cavity, a distance between a point in the space above the second portion, which is farthest from an inner surface of the mold in the space above the second portion, and the inner surface of the mold in the space above the second portion is larger than a distance between a point in the space at the side of the second portion, which is farthest from an inner surface of the mold in the space at the side of the second portion, and the inner surface of the mold in the space at the side of the second portion.

5. The method according to claim 1, wherein the cavity is formed so that a height of the space at the side of the second portion is decreased toward a downstream in a resin flowing direction.

6. The method according to claim 1, wherein the cavity is formed so that a cross-sectional area of a resin flow channel in the space at the side of the second portion is decreased toward a downstream direction.

7. The method according to claim 1, wherein the insert member and other insert members are connected with each other like a hoop, and
wherein the insert member and the other insert members are sequentially conveyed and set to the cavity.

8. A device for integrally molding an insert member and resin, the insert member comprising a bending portion, a first portion, and a second portion, the bending portion being interposed between the first portion and the second portion, the device comprising:
a holding portion configured to securely hold the first portion;
a surface configured to contact a bottom surface of the second portion; and
a gate configured to inject resin from a position nearer to the first portion than to the second portion, into a cavity,
wherein the cavity has a shape which causes a flow speed of the resin in a space above the second portion to be higher than a flow speed of the resin in a space at a side of the second portion.

9. The device according to claim 8, wherein, in the cavity, a height of the space above the second portion from a top surface of the second portion to a ceiling of the cavity is higher than a height of the space at the side of the second portion from a floor surface of the cavity to a ceiling of the cavity.

10. The device according to claim 8, wherein, in the cavity, a cross-sectional area of a resin flow channel in the space above the second portion is larger than a cross-sectional area of a resin flow channel in the space at the side of the second portion.

11. The device according to claim 8, wherein, in the cavity, a distance between a point in the space above the second portion, which is farthest from an inner surface of a mold in the space above the second portion, and the inner surface of the mold in the space above the second portion is larger than a distance between a point in the space at the side of the second portion, which is farthest from an inner surface of the mold in the space at the side of the second portion, and the inner surface of the mold in the space at the side of the second portion.

12. The device according to claim 8, wherein the cavity is formed so that a height of the space at the side of the second portion is decreased toward a downstream in a resin flowing direction.

13. The device according to claim 8, wherein the cavity is formed so that a cross-sectional area of a resin flow channel in the space at the side of the second portion is decreased toward a downstream in a resin flowing direction.

14. The device according to claim 8, further comprising a mechanism configured to sequentially convey the insert member and other insert members, connected with each other like a hoop, and sequentially set the insert member and the other insert members to the cavity.
